(19) United States
(12) Patent Application Publication
(10) Pub. No.: US 2025/0376230 A1
(43) Pub. Date: Dec. 11, 2025

(54) STEERING COLUMN MOUNTED CADDY ASSEMBLY

(71) Applicant: Fairway Bikes, Inc., Woodinville, WA (US)

(72) Inventors: Alex Millie, San Francisco, CA (US); James A. Billmaier, Woodinville, WA (US); Jeffrey Borges Jones, Los Angeles, CA (US)

(73) Assignee: Fairway Bikes, Inc., Woodinville, WA (US)

(21) Appl. No.: 19/212,160

(22) Filed: May 19, 2025

Related U.S. Application Data
(60) Provisional application No. 63/656,513, filed on Jun. 5, 2024.

(51) Int. Cl. B62J 7/06

(52) U.S. Cl. CPC B62J 7/06

(57) ABSTRACT

Caddy assemblies formed from a top housing, outer shell, and inner shell that mate together into an assembled form such that a prow is formed, and in the assembled form a storage basin of the assembly is overhung by the prow is accessible from front and sides of the assembly.

### CROSS REFERENCE TO RELATED APPLICATIONS

This application claims priority and benefit under 35 U.S.C. 119 (e) to U.S. Application Ser. No. 63/656,513, “STEERING COLUMN MOUNTED CADDY ASSEMBLY”, filed on Jun. 5, 2024, the contents of which are incorporated herein by reference in their entirety.

### BACKGROUND

Conventional vehicular caddy assemblies (e.g., armrests and cupholders) are often limited in their accessibility and carrying capacity. Additionally they are often unsuited for vehicles such as bicycles, scooters, or carts with exposed front steering columns, and may be particularly limited in their ability to provide support structures for manual activities such as writing and reading.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts components of a caddy assembly in accordance with one embodiment.

FIG. 2 depicts an assembled view of a caddy system in accordance with one embodiment.

FIG. 3A depicts a top view of an outer shell component in accordance with one embodiment.

FIG. 3B depicts a front view of an outer shell component in accordance with one embodiment.

FIG. 3C depicts a side view of an outer shell component in accordance with one embodiment.

FIG. 4A depicts a back view of an inner shell component in accordance with one embodiment.

FIG. 4B depicts a top view of an inner shell component in accordance with one embodiment.

FIG. 4C depicts a front view of an inner shell component in accordance with one embodiment.

FIG. 4D depicts a side view of an inner shell component in accordance with one embodiment.

FIG. 5A depicts a top view of a top housing component in accordance with one embodiment.

FIG. 5B depicts a side view of a top housing component in accordance with one embodiment.

FIG. 5C depicts a bottom view of a top housing component in accordance with one embodiment.

FIG. 6A depicts a top view of a back housing component in accordance with one embodiment.

FIG. 6B depicts a front view of a back housing component in accordance with one embodiment.

FIG. 6C depicts a side view of a back housing component in accordance with one embodiment.

### DETAILED DESCRIPTION

Herein the terms “plate” or “panel” do not imply any particular or required material composition (e.g., metal, plastic).

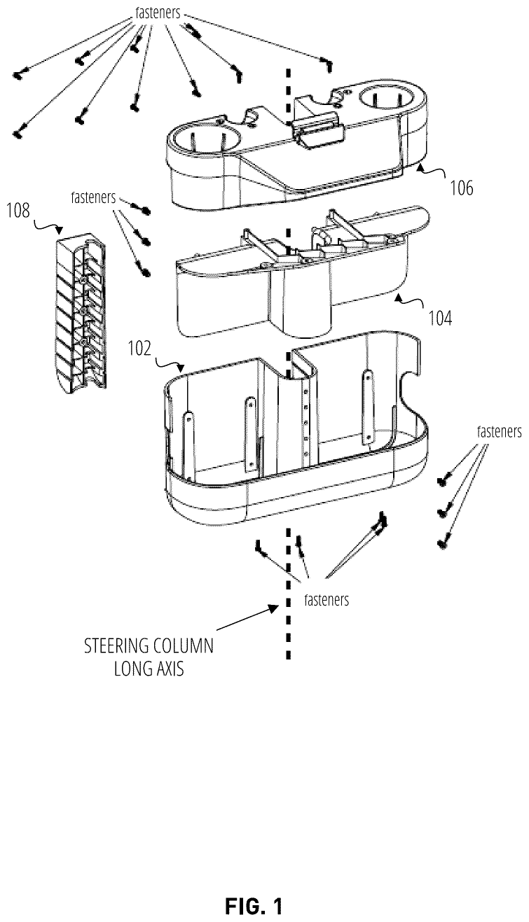

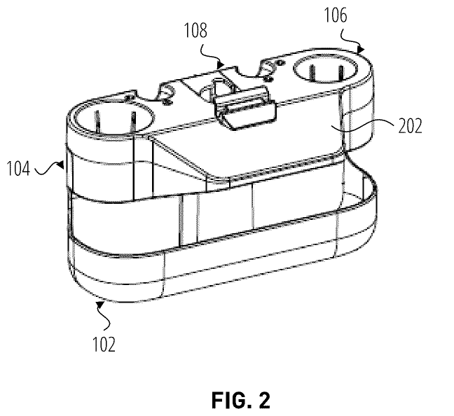

FIG. 1 depicts components of a caddy assembly in accordance with one embodiment. FIG. 2 depicts an assembled view of the components depicted in FIG. 1. The caddy assembly comprises an outer shell 102, an inner shell 104, a top housing 106, and a back housing 108. Embodiments of each of these components are described in more detail below and in subsequent drawings.

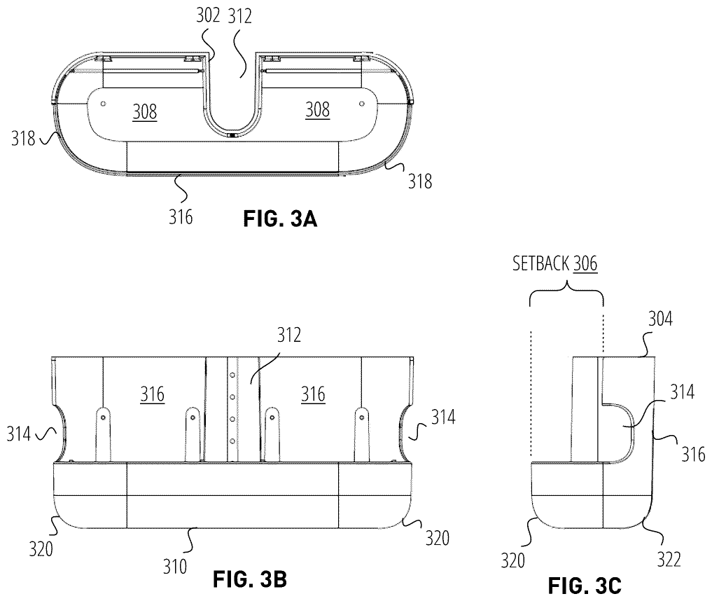

FIG. 3A-FIG. 3C depict an outer shell 102 component in accordance with one embodiment. An outer shell 102 in one embodiment comprises a sleeve 302 aligned with side panels 304. A setback 306 provides access to a cargo cavity 308 in a basin 310. A through channel 312 (e.g., for a steering column) extends through the sleeve 302 and through the cargo cavity 308 in the basin 310. Lateral recesses 314 are formed in the side panels 304 providing additional access points to the cargo cavity 308. The side panels 304, basin 310, and back panel 316 comprise rounded regions 318, 320, and 322.

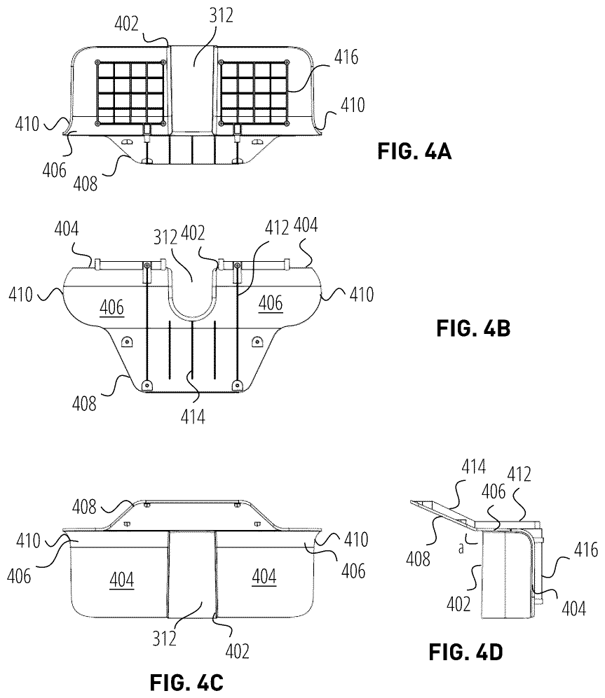

FIG. 4A-FIG. 4D depict an inner shell 104 component in accordance with one embodiment. The inner shell 104 comprises a sleeve 402 and an opening in a back panel 404 to accommodate the through channel 312. A cap plate 406 of the inner shell 104 is formed to extend into a prow 408 at an angle α relative to the sleeves 402. In various embodiments the angle a may range between 5° and 45° from perpendicular to the through channel 312.

The cap plate 406 comprises rounded regions 410 that align in position and curvature with the rounded regions 318, 320, 322 of the outer shell 102. The back panel 404, cap plate 406, and prow 408 comprise ribs 412, 414 and 416 for reinforcement.

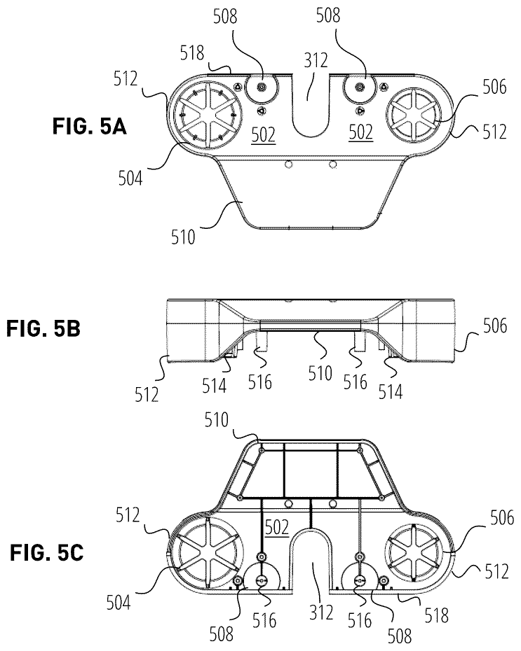

FIG. 5A-FIG. 5C depict a top housing 106 component in accordance with one embodiment. The top housing 106 comprises a top plate 502 formed to accommodate the through channel 312. The top plate 502 further comprises a first cavity 504, a second cavity 506, and third cavities 508. The top plate 502 is formed to transition into a prow 510 that mates with the prow 408 of the inner shell 104. The top plate 502 is further formed with rounded regions 512 that align in position and curvature with the rounded regions 410 of the inner shell 104.

In the depicted embodiment the cavity 504 has a larger circumference than the cavity 506, and each of these have a larger circumference than the cavities 508. The cavity 504 and the cavity 506 may comprise drains 514 to remove fluid that enters these cavities. The cavities 508 may also be fitted with drains 516. The cavities 508 may be located on the top plate 502 such that a portion of the cavities 508 is transected by the back panel 518.

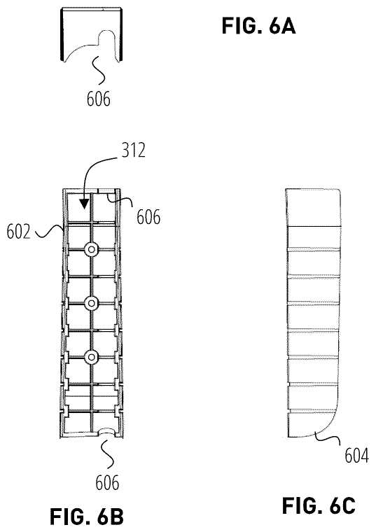

FIG. 6A-FIG. 6C depict a back housing 108 component in accordance with one embodiment. The back housing 108 comprises a housing 602 formed with a rounded edge 604 and a contouring 606. The housing 602 forms a chase to accommodate the through channel 312, and the contouring 606 is formed to match a cross sectional shape of the member that will traverse the through channel 312, e.g., a particular steering column cross section. As depicted in FIG. 1, the chase may have a length coincident with an extent of the back panel 316 of the outer shell 102, the back panel 404 of the inner shell 104, and the back panel 518 of the top housing 106.

Referring back to FIG. 2, the top housing 106, outer shell 102, and inner shell 104 align in position and curvature into an assembled form such that a unified prow 202 with rounded corners is formed from the prow 408 and prow 510. The assembled form is suited for mounting to a steering column traversing the through channel 312. Additionally in the assembled form, the basin 310 is accessible from the front and sides and is overhung by the unified prow 202. Additionally in the assembled form, the curvatures of the various components align in position and curvature with curvature of the unified prow 202.

### LISTING OF DRAWING ELEMENTS

102 outer shell
104 inner shell
106 top housing
108 back housing
202 unified prow
302 sleeve
304 side panel
306 setback
308 cargo cavity
310 basin
312 through channel
314 lateral recesses
316 back panel
318 rounded region
320 rounded region
322 rounded region
402 sleeve
404 back panel
406 cap plate
408 prow
410 rounded region
412 rib
414 rib
416 rib
502 top plate
504 cavity
506 cavity
508 cavity
510 prow
512 rounded region
514 drain
516 drain
518 back panel
602 housing
604 rounded edge
606 contouring

Within this disclosure, different entities (which may variously be referred to as “units,” “circuits,” other components, etc.) may be described or claimed as “configured” to perform one or more tasks or operations. This formulation-[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112 (f) for that claim element. Accordingly, claims in this application that do not otherwise include the “means for” [performing a function] construct should not be interpreted under 35 U.S.C § 112 (f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the intended invention as claimed. The scope of inventive subject matter is not limited to the depicted embodiments but is rather set forth in the following Claims.

What is claimed is:

1. An assembly comprising:
a top housing comprising a first prow;
an outer shell comprising a basin;
an inner shell comprising a second prow; and
the top housing, the outer shell, and the inner shell configured to mate into an assembled form comprising a unified prow overhanging the basin, the unified prow formed from the first prow and the second prow.

2. The assembly of claim 1, the top housing, the outer shell, and the inner shell further comprising back panels formed such that the assembled form comprises a through channel configured to receive a back housing and a vehicle steering column.

3. The assembly of claim 2, wherein the second prow forms an angle between 5 and 45 degrees relative to perpendicular to the through channel.

4. The assembly of claim 1, the assembled form formed such that the basin is accessible from front and side regions.

5. The assembly of claim 1, wherein the inner shell comprises a cap plate.

6. The assembly of claim 5, the cap plate comprising rounded regions that align in position and curvature with rounded regions of the outer shell.

7. The assembly of claim 1, the top housing comprising a top plate.

8. The assembly of claim 7, wherein the top plate is formed with rounded regions that align in position and curvature with rounded regions of the inner shell.

9. The assembly of claim 7, wherein the top plate comprises a plurality of cavities.

10. The assembly of claim 9, wherein at least some of the cavities comprise drains to remove fluid that enters the cavities.

11. The assembly of claim 1, further comprising a back housing.

12. The assembly of claim 11, the back housing forming a chase to accommodate a through channel of the inner shell.

13. The assembly of claim 12, the chase comprising a length coincident with an extent of a back panel of the outer shell, a back panel of the inner shell, and a back panel of the top housing.
